(19) United States
(12) Patent Application Publication
(10) Pub. No.: US 2021/0043958 A1
(43) Pub. Date: Feb. 11, 2021

(54) AQUEOUS COMPOSITION AS ELECTROLYTE COMPRISING IONIC LIQUIDS OR LITHIUM SALTS

(71) Applicants: KIST EUROPE FORSCHUNGSGESELLSCHAFT MBH, Saarbrücken (DE); CMBLU PROJECKT AG, Alzenau (DE)

(72) Inventors: Ruiyong CHEN, Saarbrücken (DE); Ruijie YE, Berlin (DE); Rolf HEMPELMANN, St. Ingbert (DE); Sangwon KIM, Saarbrücken (DE); Alexander MÖLLER, Hanau (DE); Jan HARTWIG, Alzenau (DE); Nastaran KRAWCZYK, Fulda (DE); Peter GEIGLE, Alzenau (DE)

(21) Appl. No.: 16/969,101

(22) PCT Filed: Feb. 26, 2019
(86) PCT No.: PCT/EP2019/054763

§ 371 Date: Aug. 11, 2020

(30) Foreign Application Priority Data
Mar. 12, 2018 (EP) PCT/EP2018/056087

(51) Int. Cl. H01M 8/18; H01M 8/08; B01J 41/13

(52) U.S. Cl. CPC H01M 8/188; H01M 8/08; H01M 2300/0014; H01M 2300/0045; H01M 2300/0005; B01J 41/13

(57) ABSTRACT

The present invention relates to aqueous solution containing at least one ionic liquid and/or at least one lithium salt as supporting components and at least one redox active species. It thereby allows the solution to be used as an electrolyte improving the performance and characteristics for redox active organics in batteries. Moreover, the present invention refers to the use of such solutions as electrolytes in batteries and to batteries containing such solutions.

### TECHNICAL FIELD

The present invention is related to an aqueous composition or solution comprising ionic liquids and/or lithium salts suitable and a redox active species, in particular an organic redox active species, suitable for use as an electrolyte, in particular for use as an electrolyte in redox flow batteries. Moreover the present invention relates to the use of such a composition or solution for use as an electrolyte in batteries, in particular redox flow batteries and to a redox flow battery comprising such compositions or solutions.

### BACKGROUND

High performance, low cost and safe energy storage systems are essential for sustainable energy strategies. Redox flow batteries offer a promising approach due to their economy and scalability, especially for large-scale stationary applications compared to other electrochemical energy storage systems (G. L. Soloveichik, Chem. Rev., 2015, 115, 11533). By storing energy in an electrolyte in external tanks, redox flow batteries offer the option to decouple the energy and power of the system, which creates design flexibility for practical applications. The performance of redox flow batteries generally depends e.g. on the overall cell voltage, the concentration of active species in electrolytes and the operation current density upon cycling.

Various disadvantages exist for conventional redox flow battery systems based on transition metal cations as redox species (L. Li, et al., Adv. Energy Mater., 2011, 1, 394). For example, numerous prior art systems use electrolytes with low chemical and electrochemical stability. Thereby, precipitate and gas evolution may occur upon operation with varied temperatures or voltages. External devices to control the operating conditions, to manage heat generation and to monitor the degree of oxidation/reduction of active species typically significantly increase the complexity and the cost of the total system. In addition, conventional prior art aqueous-based redox flow batteries suffer from low operation voltage due to limits for the electrochemical stability window of water (R. Chen, et al., Chapter: “Redox flow batteries: fundamentals and applications”, Redox: Principles and Advance Applications, M. A. A. Khalid (Ed.), InTech, 2017, 103). Also, the energy density (typically below 30 Wh L⁻¹) is limited due to low solubility of active species (for instance, about 1.6 M for vanadium species for vanadium redox flow batteries). Although organic solvents may afford higher voltage operation (for instance, about 2 V for a V(acac)₃ system), they typically suffer from flammability (thereby raising safety concerns), evaporation loss (problems related to storage, transport, and pollution) and low or very low solubility (about 0.1 M) for electroactive species (W. Wang, et al., Adv. Funct. Mater., 2013, 23, 970). Therefore, there is a need for more potent, readily available and directly employable, safe and preferably low cost electrolytes for redox flow battery systems.

Unlike other redox flow batteries systems utilizing the redox chemistry of transition metals, the newly emerging systems using organic molecules as redox active components became lately more attractive as an alternative (J. Winsberg, et al., Angew. Chem. Int. Ed., 2017, 56, 686). Organic materials are relatively inexpensive and structurally diverse. Synthesis and chemical structure of organic molecules can be designed on purpose. Organics can be obtained from natural sources. However, some challenges remain, such as low solubility of organics in aqueous solutions and limited cell voltage due to the narrow electrochemical window of water.

### SUMMARY OF THE INVENTION

It is an object of the present invention to provide an electrolyte suitable for being for a battery, in particular a redox flow battery, which allows to enhance the solubility and to improve the redox properties of low-cost organic compounds as redox-active species and to provide a battery, in particular a redox flow battery, comprising such an electrolyte.

The present invention thereby solves the object by the provision of an aqueous solution or composition being suitable for being used as an electrolyte, redox flow battery systems comprising such aqueous solutions or compositions, and the use of such aqueous solutions or compositions according to the invention as electrolytes in redox flow batteries.

### DESCRIPTION OF THE INVENTION

The aqueous solution or composition of the invention suitable for use as an electrolyte in redox flow batteries is characterized by comprising (i) at least one ionic liquid and/or at least one lithium salt as a supporting component of the inventive solution. As a second component, the inventive composition or solution comprises (ii) at least one redox active organic compound. The terms “composition” and “solution” are used interchangeably by the present application. The present invention thereby provides a solvent based system, whereby the solvent is water. The supporting component of the inventive solution or composition allows to support and enhance the solubility of the redox active species and prevents its sublimation in an aqueous system, thereby improving the properties of the inventive solution or composition as an electrolyte for batteries.

The system may comprise—by a first embodiment—at least one “ionic liquid”, which is also termed “ionic salt”. Such “ionic liquids” structurally typically reflect organic salts, which are liquid at a temperature of less than 100° C., e.g. at room temperature. They are a supporting component of the aqueous solution or composition according to the invention, e.g. they are dissolved in the water solvent. Preferably, the at least one ionic liquid is preferably hydrophilic, e.g. exhibiting ΔGsl<−113 mJ/m2.

By a second embodiment according to the invention, at least one lithium salt is dissolved in the aqueous solvent. Typically, the inventive aqueous solution or composition comprises either hydrophilic ionic liquids or lithium salts as a component, but may also comprise both components. The aqueous solution according to the invention may comprise hydrophilic ionic liquids of the same type or a mixture of distinct hydrophilic ionic liquids, e.g. two, three or four distinct ionic liquids or more. In analogy, the aqueous solution according to the invention may comprise more than one lithium salt dissolved therein, e.g. two, three, four or more.

The organic salt typically representing the at least one hydrophilic ionic liquid may preferably be composed of a small anion, e.g. selected from the class of halogenides, preferably chloride, and a larger organic cation. The larger cation may be selected from imidazolium, pyridinium, pyrrolidium, guanidinium or ammonium. The organic cation may be alkylated by an alkyl chain of 1 to 15 carbon atoms. It is preferred that the hydrophilic ionic liquid is an imidazolium-based ionic liquid or based on quaternary ammonium salts. More specifically, the hydrophilic ionic liquid may be chosen from an organic salt selected from 1-butyl-3-methylimidazolium chloride or 1-ethyl-3-methylimidazolium chloride. The aqueous solution may also comprise a salt selected from tetrabutyl ammonium chloride or tetraethylammonium chloride.

By its second embodiment, the aqueous solution or composition according to the invention comprises at least one lithium salt, which is preferably composed of a lithium cation and a larger anion, typically of organic nature. More preferably, the aqueous solution or composition may comprise a bis(trifluoromethanesulfonyl)imide (TFSI⁻) lithium salt.

The aqueous solution according to the invention may preferably exhibit a molality of the supporting component of at least 5 m, more preferably at least 9 m. It may also exhibit a molality of the supporting component in the range of from 5 m to 20 m.

In order to be suitable for being used as an electrolyte, the aqueous solution of the invention comprises at least one redox active species of typically organic nature. The redox-active species, e.g. the organic compound of redox active character, may be selected from an unsubstituted or substituted quinone. More preferably, the quinones being comprised by the inventive solution or composition are selected from the group consisting of hydroquinones, benzoquinones or anthraquinones. They may be chosen e.g. from a hydroquinone, more specifically from a hydroquinone selected from the group consisting of 2-methoxyhydroquinone, 2,6-dimethoxyhydroquinone, and a salt of 2-[(2,5-dihydroxyphenyl) sulfanyl]ethan-1-aminium, preferably a chloride salt thereof, or from a salt of 2-methanaminium-N,N,N-triethyl-9,10-anthraquinone, preferably a bromide salt thereof.

The aqueous solution according to the invention may comprise unsubstituted or substituted quinones, preferably as disclosed above, having a solubility of more than 1 M, preferably more than 2 M in the aqueous solution or composition as defined above.

The aqueous solution or composition according to the invention may comprise at least one additive, in particular an additive for enhancing the solubility of the redox active species.

That additive may be selected from the group consisting of an inorganic acid, an organic acid and an organic base. When adding an inorganic acid, the inorganic acid may preferably be selected from the group consisting of hydrochloric acid, sulfuric acid, phosphoric acid and nitric acid or a mixture of any of the above. The aqueous solution may also comprise a carbonic acid, e.g. formic acid. When adding an organic base to the inventive solution or composition triethanolamine may be preferred.

The aqueous solution according to the invention is used as an electrolyte, in particular as an electrolyte for use batteries, such as in redox flow batteries. The battery, in particular the redox flow battery, according to the invention comprises an aqueous solution according to the invention. In addition, it may optionally comprise an anion exchange membrane and/or a cation exchange membrane. The anion exchange membrane should preferably be suitable or adapted for conducting chloride anions. The cation exchange membrane should be suitable for or should be adapted to conduct lithium cations. A preferred anion exchange membrane to be provided according to the invention is a polybenzimidazole membrane.

Ionic liquids being mixed with the water solvent or dissolved therein for providing an aqueous solution according to the first embodiment of the present invention are known to be used as environmental friendly media for many synthetic and reaction processes. Many of the physical properties of ionic liquids such as viscosity, hydrophilicity and ionic conductivity depend on the nature and size of their cation and anion constituents and thus can be adjusted by changing the molecular structure, such as by modifying the alkyl chain-length and side chains. The solubility of various redox active species in ionic liquids depends mainly on polarity and hydrogen bonding ability. Air and water stable, water soluble ionic liquids are promising for practical applications according to the present invention. The inventive aqueous solution comprising at least one ionic liquid can also inhibit sublimation of organic redox active species (such as compounds of the class of (substituted) hydroquinones or anthraquinones, e.g. 1,4-benzoquinone), which have a higher vapor pressure (0.1 mmHg or more) at room temperature. Thereby, the present invention improves the stability of the aqueous solution or composition according to the invention in terms its application as an electrolyte for batteries.

In the first embodiment directed to aqueous ionic liquid based solution or composition, the inventive solution or composition preferably comprises at least one (concentrated) ionic liquid as a supporting salt, wherein the ionic liquid preferably comprises a larger organic cation group, such as 1-butyl-3-methylimidazolium (BMIm⁺) and/or tetrabutylammonium (TBA⁺), and an anion, preferably a small anion, such as Cl⁻. However, any anion of the halogen group or other anions, such as hydroxy or organic anions, such as carbonic acids, e.g. formic acid, may be used according to the invention as well. Such a solution or composition may preferably be concentrated (e.g. containing more than 1 M or more than 2 M or more than 3 M of the at least one ionic liquid). In order to provide a concentrated solution or composition according to the invention, the molality (mol kg⁻¹ₛₒₗᵥₑₙₜ, m) of the at least ionic liquid dissolved therein may typically be larger than 2 m, or larger than 3 m or larger than 5 m or, more specifically range from 5 to 20 m.

The inventive aqueous solution or composition may be used to dissolve redox active compounds, e.g. of the hydroquinone, benzoquinone or anthraquinone class, e.g. methoxy- or ethoxy-substituted hydroquinones or benzoquinones substituted by one, two, three or four methoxy- or ethoxy-substituents, such as 2-methoxyhydroquinone or 2,6-dimethoxyhydroquinone, effectively. The concentration of the redox active species in the inventive solution or composition is preferably larger than 1 M or larger than 2M or larger than 3M. As an example, the solubility of 2-methoxyhydroquinone can be increased from 1.8 M in pure water to 6 M (corresponding to a theoretical capacity of 160 Ah L⁻¹) in a concentrated BMImCl containing aqueous solution according to the invention.

To further enhance the solubility of the at least one ionic liquid component, it may be preferred to add an acidic additive, such as hydrochloric acid, to the concentrated electrolyte solution or composition. Its concentration may typically range from 0.2 to 1 M. It may also be preferred to employ Cl⁻ anions as charge carrier for a redox flow battery according to the invention, as they allow the use of low cost anion exchange membranes for the batteries. Moreover, Cl⁻ exhibits good mobility in aqueous solutions, i.e. for in the inventive aqueous solution or composition, thereby further contributing to the performance of the battery.

By the second embodiment, the redox-active species may be dissolved in an aqueous solution or composition containing at least one lithium salt, wherein the anion of the lithium salt is preferably a TFSI⁻ anion, which may improve the solvation process. As disclosed above, the redox active species may be an organic redox-active compound, e.g. 2-methoxyhydroquinone or other methoxy-substituted hydroquinones or benzoquinones, may be dissolved in a water solvent system (to provide the inventive aqueous solution or composition) with a concentration of more than 2.0 M or more than 3M, e.g. by 4.2 M, thereby providing aqueous solution or composition according to the invention comprising at least one lithium salt, e.g. comprising bis(trifluoromethanesulfonyl)imide lithium salt (LiTFSI), preferably concentrated other lithium salts such as Lithium bis(fluorosulfonyl)imide, Lithium trifluoromethanesulfonate. The molality (mol kg⁻¹ₛₒₗᵥₑₙₜ, m) of the lithium salt for the inventive solution or composition may preferably be larger than 2 m or larger than 3 m or larger than 5 m or the molality may specifically range from 5 m to 20 m. An electrolyte comprising such at least one lithium salt as supporting salt for the redox active species allows the use of a cation exchange membrane to conduct Li⁺. By the addition of an organic or inorganic acid, e.g. HCl, both H⁺ and Li⁺ can be used as charge carriers for a redox flow battery, further improving the battery's performance.

Accordingly, the present invention more specifically provides an aqueous ionic liquid containing solution or an aqueous lithium salt containing solution suitable for being used as an electrolyte for a battery, in particular a redox flow battery, comprising a bi- or multivalent metal ion as a anolyte, preferably V3+ and Zn2+.

Also, 2-[(2,5-dihydroxyphenyl)sulfanyl]ethan-1-amonium chloride may be used as a catholyte. It may be dissolved in pure water with a concentration of 2 M. However, that redox active compound does not maintain stable and reversible electrochemical performance over cyclic voltammetry (CV) cycling. By using e.g. a aqueous ionic liquid (e.g. BMImCl) containing or lithium salt (e.g. LiTFSI) containing solution as supporting salt, enhanced electrochemical redox reversibility has been observed for 2-[(2,5-dihydroxyphenyl)sulfanyl]ethan-1-amonium chloride from CV measurements and galvanostatic charge/discharge over a long-term cycling. Accordingly, the present invention may provide a redox flow battery comprising at least one ionic liquid containing aqueous solution or at least one lithium salt containing aqueous solution or containing both at least one ionic liquid and at least one lithium salt, comprising 2-[(2,5-dihydroxyphenyl)sulfanyl]ethan-1-amonium chloride as a catholyte, preferably in a concentration of more than 0.05 M or more than 0.1 M or more than 0.5 M or, more specifically, ranging from 0.08 to 1 M.

Modification of the ionic liquid and/or lithium salt containing aqueous solution or composition of the invention by the addition of HCl does not only promote solubility of the components of the inventive composition, but can also enhance the reaction kinetics, as observed from the CV measurements. Low polarization and fast reaction can be achieved accordingly. These are important for a redox flow battery with high voltage efficiency and high energy efficiency.

A redox flow battery according to the present invention comprises the inventive solution or composition. It may preferably comprise an anolyte comprising V³⁺, a catholyte comprising a hydroquinone or benzoquinone derivative, preferably methoxy-substituted hydroquinone or benzoquinone (e.g. 2-methoxyhydroquinone) dissolved in an aqueous solution or composition according to the invention containing a ionic liquid cation, e.g. BMIm⁺, and anions, preferably Cl⁻ ions, and, optionally, an anion exchange membrane separating the anolyte and the catholyte. Accordingly, the 2-methoxyhydroquinone/V battery system may employed by the use of the inventive solution or composition. It may e.g. comprise a cross-linked methylated polybenzimidazole membrane to conduct anions. The 2-methoxyhydroquinone/V system according to the invention typically has an average discharge voltage of about 0.8 V.

The present invention is also directed to high cell voltage redox flow battery systems. According to the invention a hydroquinone or benzoquinone based redox flow battery, e.g. a methoxy-substituted hydroquinone, e.g. 2-methoxyhydroquinone/Zn battery system may be employed with the redox active species being dissolved in the inventive aqueous solution or composition. Thereby, the Zn²⁺/Zn redox couple may be employed as anolyte/anode. A discharge voltage of about 1.25 V is e.g. observed for the 2-methoxyhydroquinone/Zn battery system. Free selection of the anolyte allows the system with high overall cell voltage.

The present invention also provides a redox flow battery comprising an aqueous solution or composition comprising V³⁺ as an anolyte, and 2-[(2,5-dihydroxyphenyl)sulfanyl]ethan-1-amonium chloride as a catholyte. The aqueous solution preferably contains at least one ionic liquid having cation, preferably containing BMIm⁺ as the cation, and an anion, preferably Cl⁻ ions, and, optionally, an anion exchange membrane separating the anolyte and the catholyte. The concentration of 2-[(2,5-dihydroxyphenyl)sulfanyl]ethan-1-amonium chloride as the catholyte is preferably larger than 0.08 M and more specifically ranges from 0.08 to 1 M. The operation current density preferably ranges from 10 to 100 mA cm⁻². The capacities and cycling efficiencies reach constant values after about initial 10 cycles. A reversible capacity of about 60 mAh (or 6 Ah L⁻¹) has been obtained for 1 M 2-[(2,5-dihydroxyphenyl) sulfanyl]ethan-1-aminium chloride.

As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Table 1: Solubility of some organics in 10 m water-ionic liquid or water-lithium salt mixtures without and with additives

FIGS. 1a and 1b show the chemical structure of 2-methoxyhydroquinone and its solubility in pure water and other aqueous ionic liquids, aqueous lithium salt (molality: 10 m), with and without the addition of 1 M HCl.

FIGS. 2a and 2b compare cyclic voltammetry curves of 0.1 M 2-methoxyhydroquinone in pure water and other aqueous ionic liquid, aqueous lithium salt (molality: 10 m), with and without the addition of 1 M HCl. Potential sweep rate: 50 mV s⁻¹. Working electrode: glassy carbon; Counter electrode: Pt foil; Reference electrode: Ag wire.

FIGS. 3a and 3b compare the cell resistance measured from impedance and voltage profiles (50^{th} cycle) of redox flow batteries with a commercial Nafion 117 membrane and a cross-linked polybenzimidazole membrane. Catholyte: 10 mL 0.08 M 2-methoxyhydroquinone in 10 m BMImCl with 1 M HCl; anolyte: 10 mL 0.16 M V³⁺ with 1 M HCl and saturated NaCl. FIG. 3c shows the charge/discharge capacities, coulombic efficiency, voltage efficiency, and energy efficiency with the crosslinked polybenzimidazole anion exchange membrane. Flow rates: 35 mL min⁻¹. Current density: 10 mA cm⁻².

FIG. 4 Voltage profile and cycling stability of a 2-methoxyhydroquinone/Zn hybrid redox flow battery. Catholyte: 10 mL 0.3 M 2-methoxyhydroquinone and 0.5 M HCl; Anolyte: 10 mL 0.3 M ZnCl₂ and 0.3 M NH₄Cl. Flow rates: 35 mL min⁻¹. Current density: 1.25 mA cm⁻². Membrane: a crosslinked polybenzimidazole anion exchange membrane.

FIG. 5a depicts the chemical structure of 2-[(2,5-dihydroxyphenyl)sulfanyl]ethan-1-aminium chloride. FIGS. 5b and 5c show the cyclic voltammetry curves of 0.1 M 2-[(2,5-dihydroxyphenyl) sulfanyl]ethan-1-amonium chloride in pure water and in 1 M HCl. Potential sweep rate: 20 mV s⁻¹. Working electrode: glassy carbon; Counter electrode: Pt foil; Reference electrode: Ag wire.

FIGS. 6a and 6b compare the cyclic voltammetry curves of 0.1 M 2-[(2,5-dihydroxyphenyl) sulfanyl]ethan-1-amonium chloride in concentrated LiTFSI and BMImCl without and with the addition of 1 M HCl. Potential sweep rate: 20 mV s⁻¹. Working electrode: glassy carbon; Counter electrode: Pt foil; Reference electrode: Ag wire.

FIGS. 7a and 7b show voltage profiles, cycling efficiencies and capacities of a redox flow battery with a crosslinked polybenzimidazole membrane. Catholyte: 10 mL 0.08 M 2-[(2,5-dihydroxyphenyl) sulfanyl]ethan-1-amonium chloride in 10 m BMImCl with 1 M HCl; anolyte: 10 mL 0.16 M V³⁺ with 1 M HCl and saturated NaCl. Flow rates: 35 mL min⁻¹. Current density: 10 mA cm⁻².

FIGS. 8a and 8b show voltage profiles, cycling efficiencies and capacities of a redox flow battery with a crosslinked polybenzimidazole membrane. Catholyte: 10 mL 0.5 M 2-[(2,5-dihydroxyphenyl) sulfanyl]ethan-1-amonium chloride in 10 m BMImCl with 1 M HCl; anolyte: 10 mL 1.6 M V³⁺ with 1 M HCl and saturated NaCl. Flow rates: 35 mL min⁻¹. Current density: 25 mA cm⁻².

FIGS. 9a and 9b show voltage profiles, cycling efficiencies and capacities of a redox flow battery with a crosslinked polybenzimidazole membrane. Catholyte: 10 mL 1.0 M 2-[(2,5-dihydroxyphenyl) sulfanyl]ethan-1-amonium chloride in 10 m BMImCl with 1 M HCl; anolyte: 20 mL 1.6 M V³⁺ with 1 M HCl and saturated NaCl. Flow rates: 35 mL min⁻¹. Current density: 100 mA cm⁻² for the first 36 cycles, then 50 mA cm⁻² for the following cycles.

TABLE 1
Solubility of some organics in 10 m water-ionic liquid or water-lithium salt mixtures
without and with additives

| | Solubility/mol L⁻¹ | | | | | | | | | | | |
|---|---|---|---|---|---|---|---|---|---|---|---|---|
| | H₂O | | | BMImCl-H₂O | | | LiTFSI-H₂O | | | TBACl-H₂O | | |
| Organics | a | b | c | a | b | c | a | b | c | a | b | c |
| 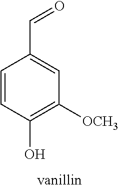 [SMILES: COc1cc(C=O)ccc1O] | <0.1 | — | — | 4.0 | — | — | 4.0 | — | — | 4.0 | — | — |
| 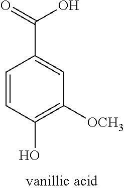 [SMILES: COc1cc(C(=O)O)ccc1O] | <0.1 | — | — | 1.0 | — | — | <0.1 | — | — | 0.1 | — | — |
| 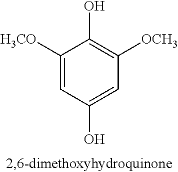 [SMILES: COc1cc(O)cc(OC)c1O] | <0.1 | <0.1 | — | <0.1 | <0.1 | — | 0.7 | 0.5 | — | 0.2 | 0.1 | — |
| 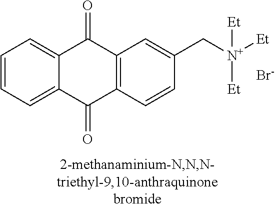 [SMILES: CC[N+](CC)(CC)Cc1ccc2c(c1)C(=O)c1ccccc1C2=O ; [Br-]] | <0.1 | — | <0.1 | <0.1 | — | <0.1 | 0.5 | — | 0.3 | <0.1 | — | <0.1 |

a: without additive; b: with 1 M HCl; c: with 0.3 g triethanolamine per mL solvent

### EXAMPLES

### Example 1

The solubility of organic compounds at room temperature was measured by adding organics into 1 mL supporting electrolyte under stirring with an increment of 0.1 mmol until the organics cannot be dissolved any more. The last recorded amount was recognized as the solubility of the organics.

Vanillin is slightly soluble in water, but has high solubility in aqueous ionic liquids. An expansion in volume of the solution was observed during the dissolution. A maximal concentration of 4 M was observed for vanillin in BMImCl—H₂O, TBACl—H₂O (tetrabutylammonium chloride) and LiTFSI—H₂O (Table 1). The solutions of vanillin in BMImCl—H₂O and TBACl—H₂O are colorless when fresh prepared, but turn yellow after two days. The solution of vanillin in LiTFSI—H₂O is also colorless but only at low concentration. With the increase of concentration, it shows a pink color. This distinct color indicates a possible coordination between lithium and vanillin.

Vanillic acid is almost insoluble in water and can only slightly be dissolved in LiTFSI—H₂O and TBACl—H₂O. Nevertheless, its solubility in 10 m BMImCl—H₂O reaches 1 M. The solution is in yellow and turns brown at higher concentration.

### Example 2

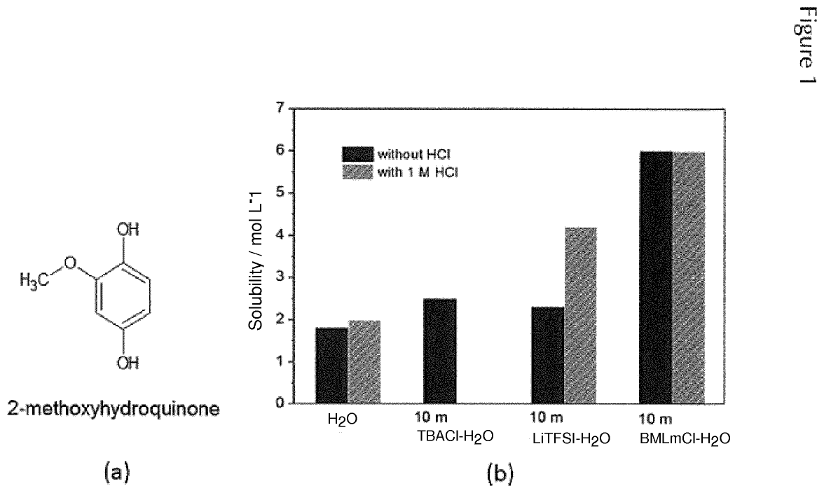

2-methoxyhydroquinone has high solubility in water (about 2 M) and its solubility in aqueous ionic liquids and the solubility in acid is better (FIG. 1) according to the invention. The low concentrated solutions show yellow to amber color, while the color turns darker with the increase of solute. High concentration of BMImCl—H₂O leads to high viscosity and the volume is expanded as much as about two times when 12 mmol MBHQ is dissolved in 1 mL BMImCl—H₂O, which gives a final concentration of 6 M.

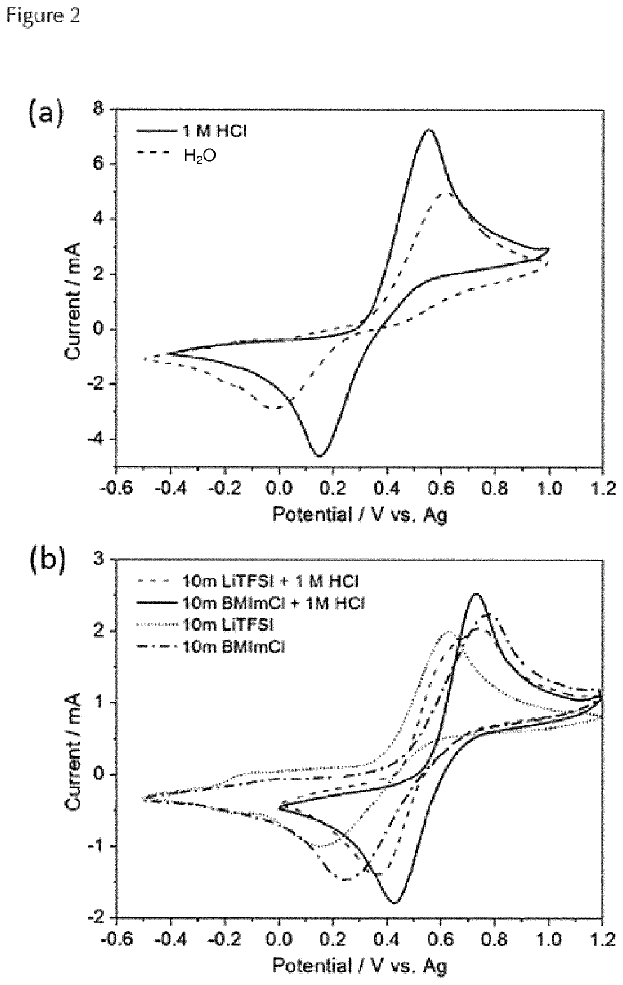

CV measurements were performed in a three-electrode cell consisting of a glassy carbon rod working electrode, a platinum foil counter electrode and a silver wire quasi-reference electrode. CV measurements of 2-methoxyhydroquinone in water (FIG. 2a) and different aqueous ionic liquids and salt (FIG. 2b) were performed.

For the CV measurement in water, KCl was added as supporting salt. 2-methoxyhydroquinone exhibits good electrochemical reactivity and reversibility. The average redox potential in water is 0.27 V vs. Ag but with large peak separation of 0.64 V (FIG. 2a).

The average redox potentials in aqueous ionic liquids and salt are generally higher than that in water, which is 0.38 vs. Ag in LiTFSI—H₂O and 0.51 V vs. Ag in BMImCl—H₂O, respectively (FIG. 2b). The highest potential occurs in TBACl—H₂O at 0.54V vs. Ag. The polarization in TBACl—H₂O is also the largest (0.87 V). In comparison, the kinetics in BMImCl—H₂O and LiTFSI—H₂O are better as the peak separation is 0.53 V and 0.48 V, respectively.

The electrochemical behavior of 2-methoxyhydroquinone was also investigated under acidic conditions (FIG. 2b). In the presence of protons, the reaction kinetics of 2-methoxyhydroquinone is significantly improved. The peak separations are reduced to 0.40 V in water, 0.30 V in BMImCl—H₂O, 0.38 V in LiTFSI—H₂O and 0.54 V in TBACl—H₂O. At the same time, protons also help enhancing the redox potential, which is raised to 0.35 V vs. Ag in water, to 0.58 V vs. Ag in BMImCl—H₂O, 0.55 V vs. Ag in LiTFSI—H₂O and to 0.58 V vs. Ag in TBACl—H₂O. In addition, acid may suppress the unwanted side reactions (demethoxylation and hydroxylation) of 2-methoxyhydroquinone.

The influence of acid on the electrochemical behavior of 2-methoxyhydroquinone was also investigated by using phosphoric acid (H₃PO₄). The acidity of phosphoric acid is relatively weak. Phosphoric acid is less corrosive compared to HCl for practical applications. With addition of H₃PO₄ from 1 M to 3 M in 10 m BMImCl—H₂O, the average redox potential of 2-methoxyhydroquinone is 0.50 V vs. Ag. However, this value is lower than that with HCl. Although the peak separation is also reduced to 0.42 V in the electrolyte with 1 M H₃PO₄, this value is still larger than that with HCl.

### Example 3

By its two methoxy groups, 2,6-dimethoxyhydroquinone is insoluble in water. Its solubility in BMImCl—H₂O as well as in TBACl—H₂O is limited. Nevertheless, the solubility of 2,6-dimethoxyhydroquinone in neutral and acidic LiTFSI—H₂O reaches 0.7 M and 0.5 M, respectively (Table 1).

### Example 4

2-methanaminium-N,N,N-triethyl-9,10-anthraquinone bromide is an organic salt containing quaternary ammonium cation and a bromide anion. The ionic configuration does not lead to a good solubility in water, in BMImCl—H₂O and in TBACl—H₂O. However, it can be well dissolved in 10 m LiTFSI—H₂O with a solubility of 0.5 M (Table 1). Pale yellow-brown precipitate was observed when the concentration of 2-methanaminium-N,N,N-triethyl-9,10-anthraquinone bromide reaches 0.3 M in 10 m LiTFSI—H₂O with the presence of triethanolamine.

2-methanaminium-N,N,N-triethyl-9,10-anthraquinone bromide is also soluble in 15 m LiTFSI—H₂O, while the solubility in 5 m LiTFSI—H₂O is poor.

With the addition of 0.3 g triethanolamine per milliliter 10 m LiTFSI supporting electrolyte, the solubility of 2-methanaminium-N,N,N-triethyl-9,10-anthraquinone bromide can reach 0.3 M.

### Example 5

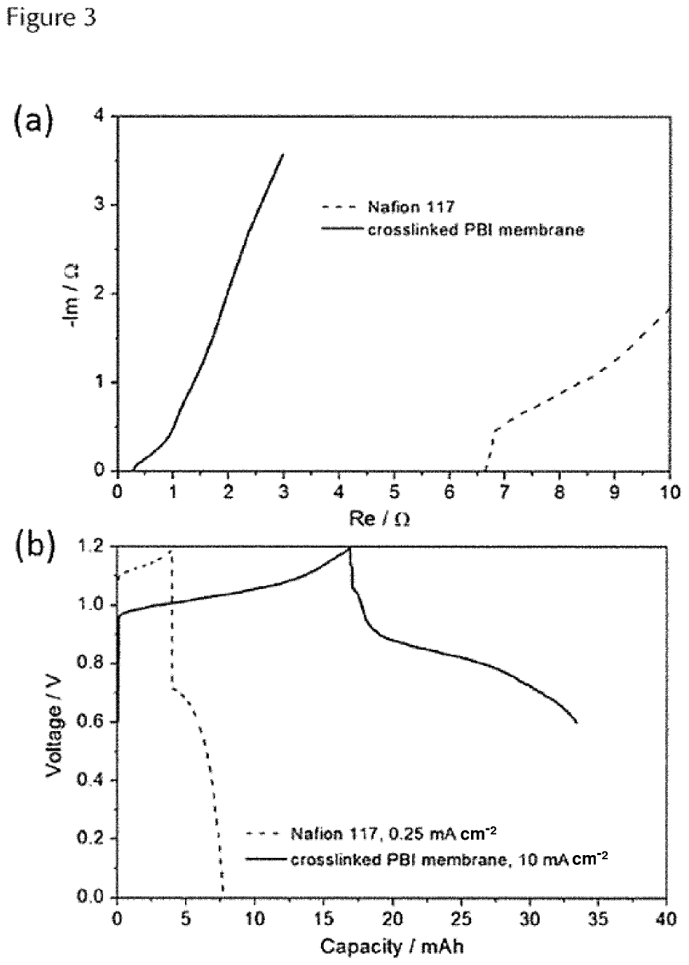

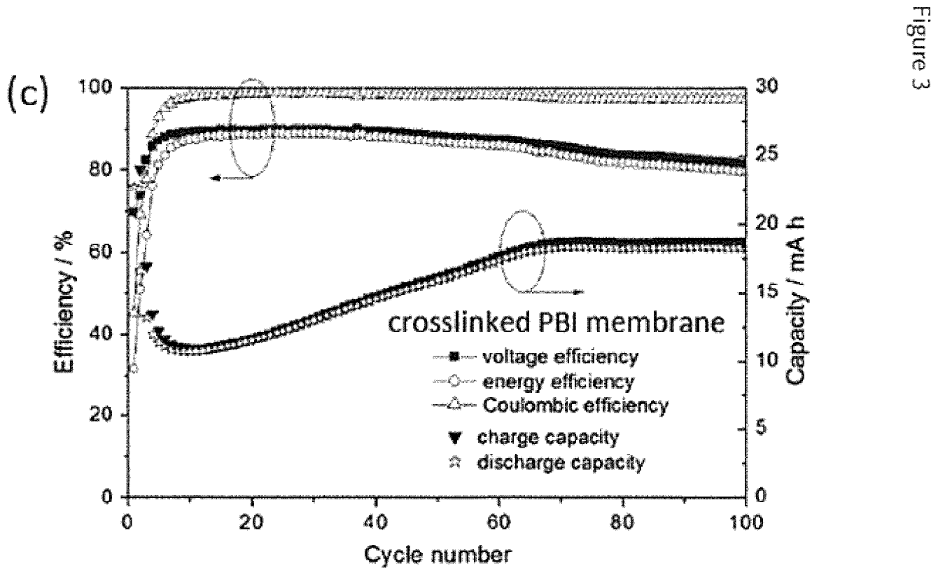

2-methoxyhydroquinone was tested as active species for catholyte (0.08 M 2-methoxyhydroquinone in 10 m BMImCl with 1 M HCl) with the combination of vanadium anolyte (FIG. 3, 0.16 M V³⁺ with 1 M HCl and saturated NaCl). V³⁺ electrolytes were obtained by diluted commercial vanadium sulfate electrolytes. 1 M HCl and saturated NaCl were added and used as anolyte. Catholyte and anolyte, each with a volume of 10 mL, were stored in two sealed glass vials.

A flow cell with an active area of 4 cm² was used for galvanostatic charge/discharge measurements. The graphite felts with uncompressed thickness of 5 mm and compression of 20% were pretreated in 3 M H₂SO₄ solution for 24 h and then thermally processed at 500° C. for 12 h in static air. Two pieces of graphite felts were used for the cathode and anode.

A commercial cation exchange membrane Nafion 117 and a crosslinked methylated polybenzimidazole membrane are compared for the cycling performance with vanadium anolyte (FIGS. 3a,3b). Polybenzimidazole membrane shows significant low resistance (0.3 Ω, FIG. 3a) from the impedance measurements, compared to the Nafion 117 membrane (6.6 Ω). Accordingly, only very low current density of 0.25 mA cm⁻² can be applied for the flow battery with Nafion 117 membrane (FIG. 3b), which has large ohmic drop, low voltage efficiency (54.5%) and low capacity (4 mAh).

In contrast, with the use of a polybenzimidazole membrane, the discharge voltage shifted up to 0.8 V with an increased voltage efficiency of 82% (FIG. 3b). In addition, the capacity increased to about 16 mAh. Over cycling (FIG. 3c), the capacity drops during the initial 10 cycles, then increase progressively to about 18 mAh after 60 cycles, then keep constant up to 100 cycles. A Coulombic efficiency of about 98% was observed.

### Example 6

2-methoxyhydroquinone was tested as active species for catholyte (0.3 M 2-methoxyhydroquinone in 10 m BMImCl with 0.5 M HCl) with the combination of zinc anode (Zn plate anode, anolyte consists of 0.3 M ZnCl₂ and 0.3 M NH₄Cl). The Zn plate with flow channels (1.6 mm in thickness, polished and then washed with 3 M H₂SO₄ and distilled water before being assembled into a cell) was sandwiched between a Cu current collector and a gasket (with a free space of 3 mm in thickness, allowing the Zn²⁺/Zn plating reactions on the surface of the Zn plate). Catholyte and anolyte, each with a volume of 10 mL, were stored in two sealed glass vials. A crosslinked methylated polybenzimidazole membrane was used.

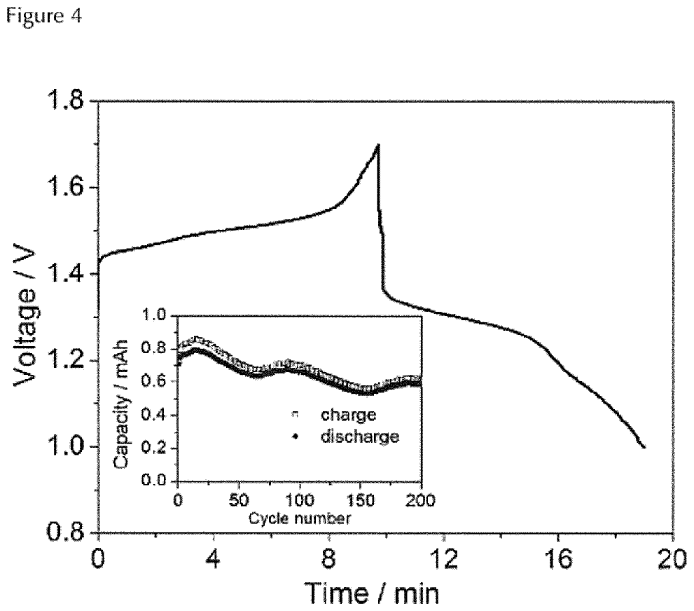

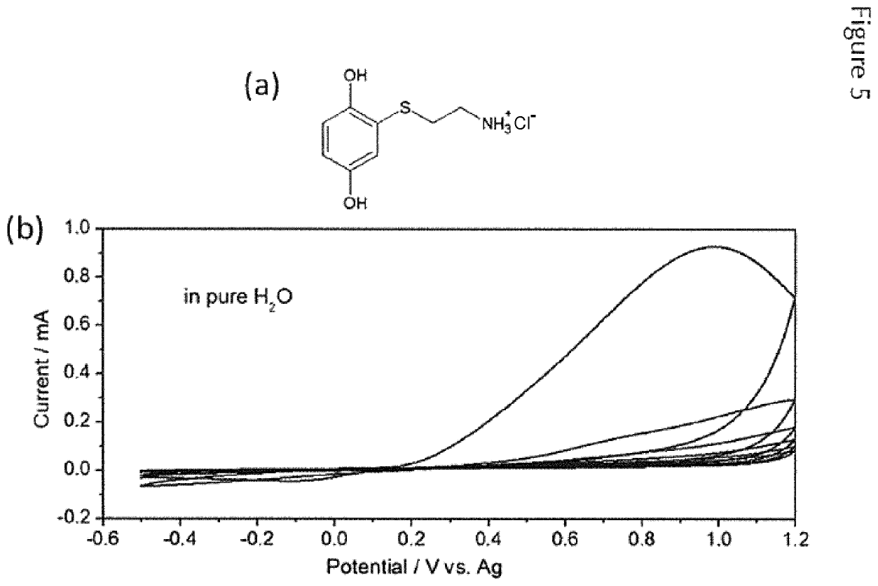

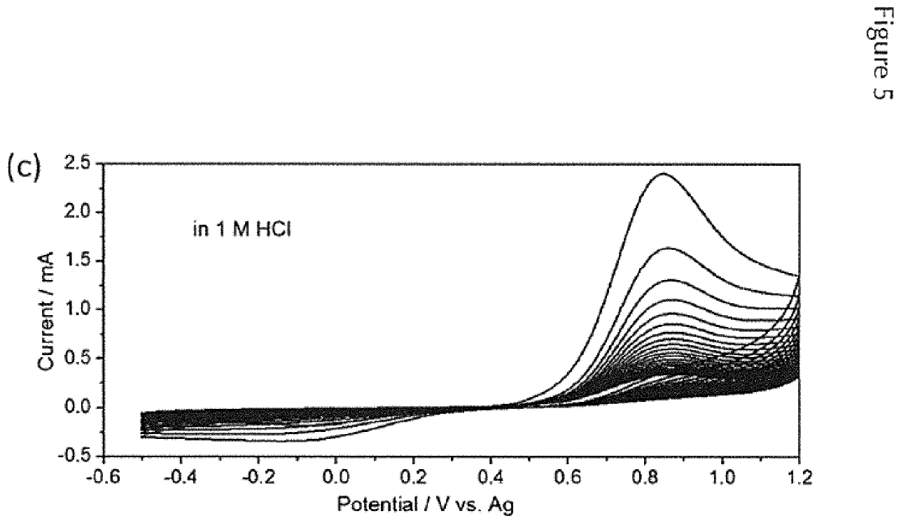

With the use of Zn anode with low negative redox potential (−0.76 V, thermodynamically), a high cell voltage of 1.25 V was obtained (FIG. 4). Over 200 cycles, steady cycling performance was observed (Inset in FIG. 4).

### Example 7

2-[(2,5-dihydroxyphenyl)sulfanyl]ethan-1-aminium chloride (FIG. 5a) is an organic salt and has high solubility in water (2 M). However, it was found chemically and electrochemically instable. CV measurements of 2-[(2,5-dihydroxyphenyl)sulfanyl]ethan-1-aminium chloride in pure water (FIG. 5b) and in 1 M HCl (FIG. 5c) showed poor redox reversibility. Only oxidation peaks in pure water can be seen, which decreases significantly over cycling. With the presence of acid, the reactivity is slightly improved. However, the oxidation product is still instable under acidic conditions and can be only partially reduced, leading to the poor reversibility.

The solubility of 2-[(2,5-dihydroxyphenyl)sulfanyl]ethan-1-aminium chloride in neutral and acidic BMImCl—H₂O was 1.2 M and 0.9 M, respectively. These values could be underestimated, as the solutions are viscous and in dark color. It is difficult to recognize whether more solute could be dissolved. The solution of 0.6 M 2-[(2,5-dihydroxyphenyl) sulfanyl]ethan-1-aminium chloride in TBACl—H₂O reaches relative high viscosity.

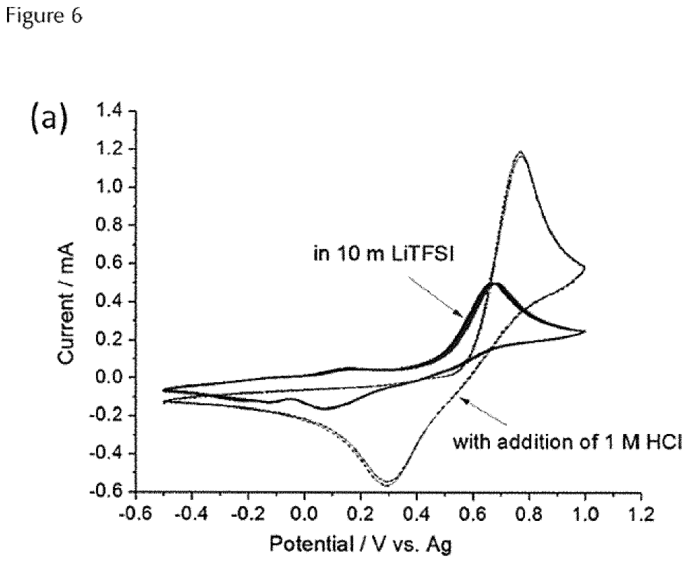

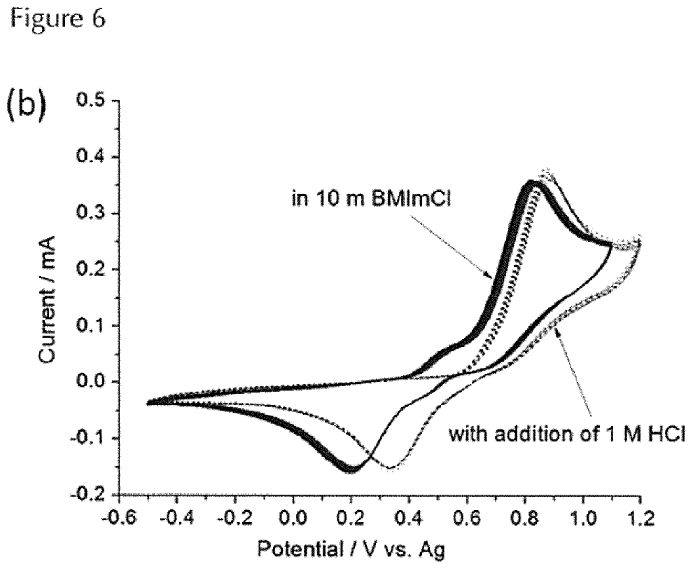

In contrast, 2-[(2,5-dihydroxyphenyl)sulfanyl]ethan-1-aminium chloride shows excellent stability and reversibility in aqueous ionic liquids or lithium salt from the CV measurements. When 2-[(2,5-dihydroxyphenyl)sulfanyl]ethan-1-aminium chloride is tested in LiTFSI—H₂O, reversible redox peak can be observed from the CV measurements (FIG. 6a). The oxidation peak appears at 0.70 V vs. Ag, whereas the corresponding reduction peak is located at 0.08 V vs. Ag. Enhanced current response has been observed by adding HCl. In addition, the polarization decreases, indicating enhanced reaction kinetics. As shown in FIG. 6b, in BMImCl—H₂O solution, a reversible redox reaction with an average oxidation and reduction potential of 0.50 V vs. Ag and a peak separation of 0.61 V was observed. With the addition of HCl, the average oxidation and reduction potential shifts to 0.61 V and the peak separation reduces by 0.07 V.

### Example 8

2-[(2,5-dihydroxyphenyl)sulfanyl]ethan-1-aminium chloride in 10 m BMImCl—H₂O containing 1 M HCl was employed as catholyte for flow battery tests. Commercial vanadium sulfate electrolytes were diluted to specific concentrations containing 1 M HCl and saturated NaCl and used as anolyte. Both electrolytes were covered by paraffin oil during the battery cycling. A crosslinked methylated polybenzimidazole membrane was used in the flow cell, allowing the transport of Cl⁻.

Different concentrations of 2-[(2,5-dihydroxyphenyl)sulfanyl]ethan-1-aminium chloride catholytes were used ranging from 0.08 to 1 M. Accordingly, V³⁺ with concentrations of 0.16 to 1.6 M were used. Excess of V³⁺ anolyte was used for 1 M 2-[(2,5-dihydroxyphenyl) sulfanyl]ethan-1-aminium chloride catholyte. Different current densities were applied from 10 to 100 mA cm⁻².

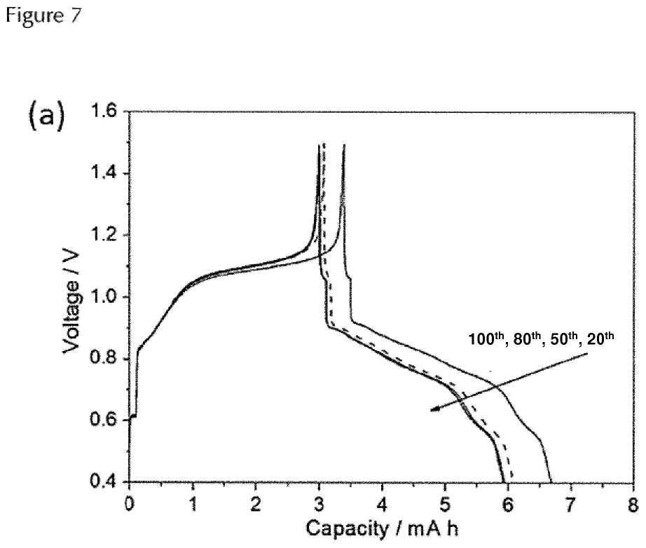

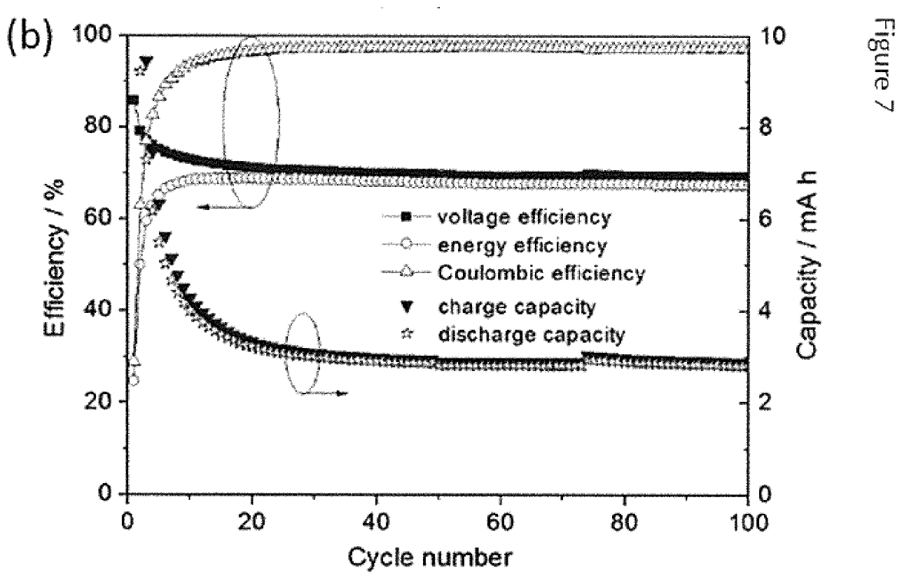

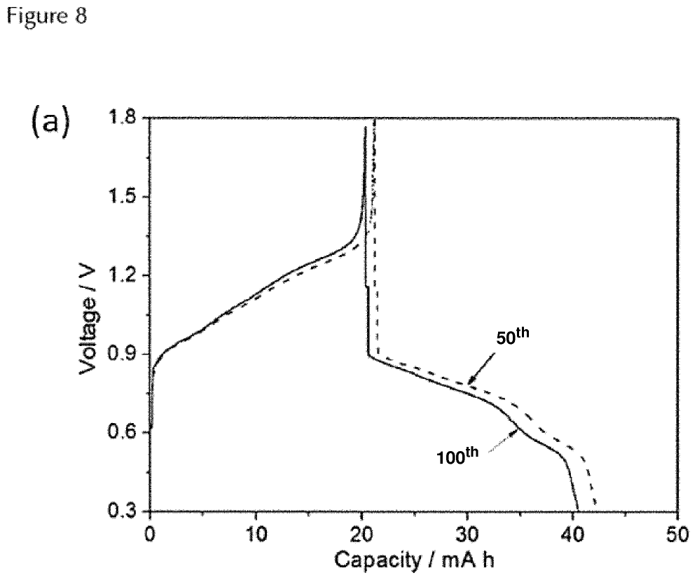

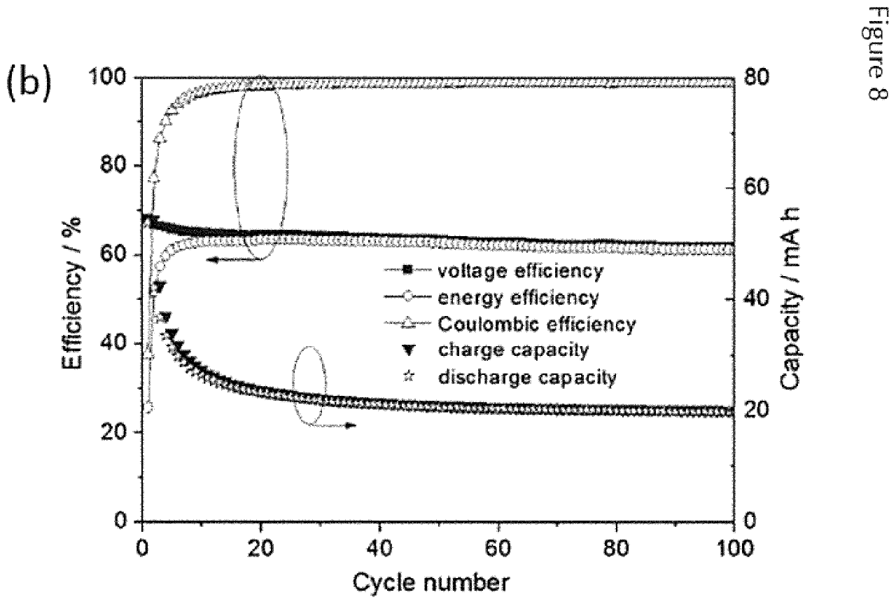

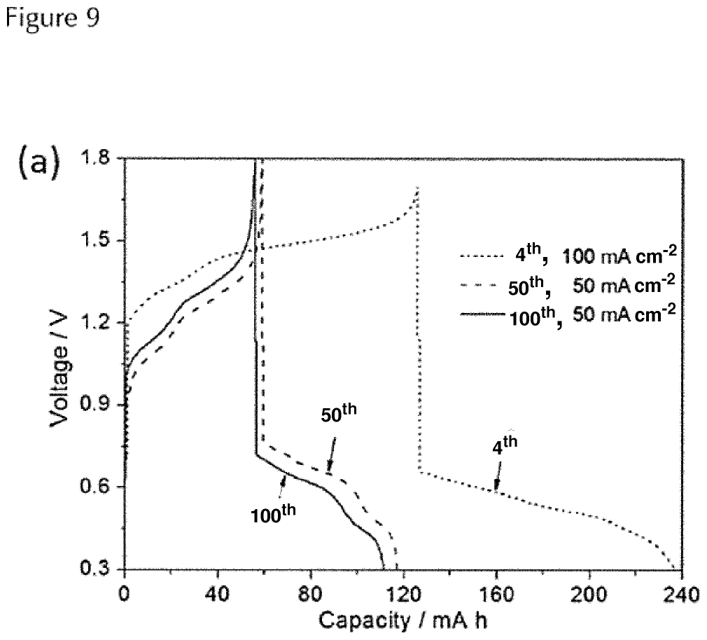

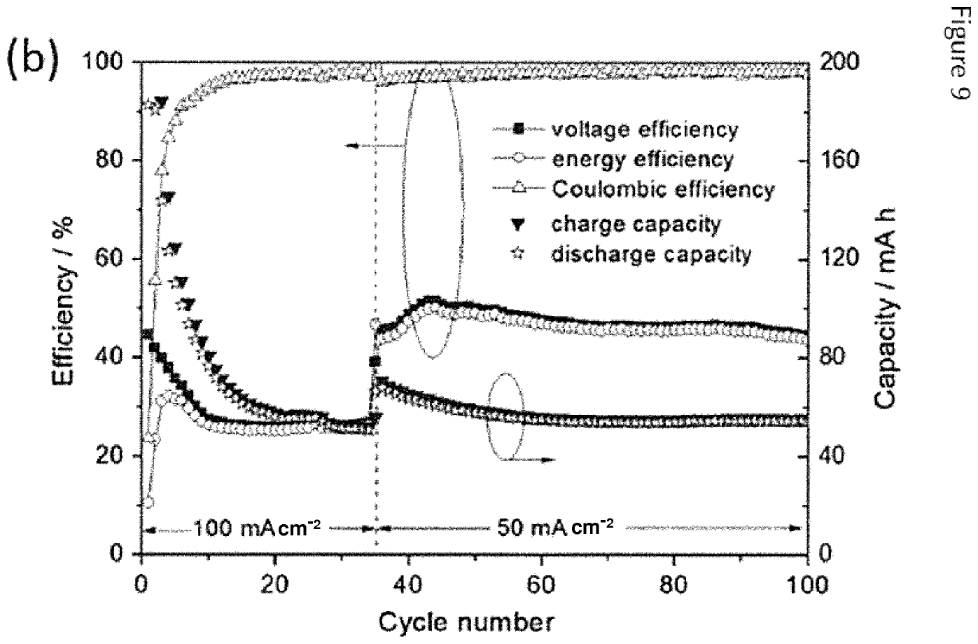

During initial 10 cycles, capacity drops were observed for all tests. Afterwards, the capacities reach steady values of about 3, 20 and 60 mAh for the battery with catholyte concentrations of 0.16 M (FIG. 7), 0.5 M (FIG. 8) and 1 M (FIG. 9), respectively. The voltage curves are relatively overlapped at the 50^{th} and the 100^{th} cycles, indicating 2-[(2,5-dihydroxyphenyl) sulfanyl]ethan-1-aminium chloride is stable over long-term cycling. At 10 and 25 mA cm⁻², average discharge voltages are located at about 0.75 V (FIG. 7a, FIG. 8a), whereas the average voltage shifts down to about 0.5 V when higher current densities of 50 and 100 mA cm⁻² were applied (FIG. 9a). The voltage efficiencies reduce from 70% at 10 mA cm⁻² (FIG. 7b) to 64% at 25 mA cm⁻² (FIG. 8b), then to 45% at 50 mA cm⁻² (FIG. 9b), respectively. Independent on the applied current densities and the concentrations of the catholytes, the Coulombic efficiencies remain about 97.5%.

1. An aqueous solution suitable for use as an electrolyte in batteries, comprising (i) as a supporting component at least one ionic liquid and/or at least one lithium salt and (ii) as a redox active component at least one redox active organic compound.

2. The aqueous solution of claim 1, comprising at least one ionic liquid, which is composed of small anions and larger organic cations.

3. The aqueous solution of claim 1, comprising at least one ionic liquid selected from the group consisting of imidazolium-based ionic liquids and quaternary ammonium salts.

4. The aqueous solution of claim 3, comprising 1-butyl-3-methylimidazolium chloride or 1-ethyl-3-methylimidazolium chloride.

5. The aqueous solution of claim 3, comprising tetrabutyl ammonium chloride or tetraethylammonium chloride.

6. The aqueous solution of claim 1, comprising at least one lithium salt, which is composed of a lithium cation and a larger anion, the at least one lithium salt being preferably an bis(trifluoromethanesulfonyl)imide lithium salt.

7. The aqueous solution of claim 1, having a molality of the support component in the range of 5 to 20 m.

8. The aqueous solution of claim 1, comprising at least one unsubstituted or substituted quinone, preferably selected from the group consisting of hydroquinones, benzoquinones or anthraquinones, as the redox active component.

9. The aqueous solution of claim 8, comprising a hydroquinone selected from the group consisting of 2-methoxyhydroquinone, 2,6-dimethoxyhydroquinone, and a salt of 2-[(2,5-dihydroxyphenyl)sulfanyl]ethan-1-aminium, preferably a chloride salt thereof.

10. The aqueous solution of claim 8, comprising a salt of 2-methanaminium-N,N,N-triethyl-9,10-anthraquinone, preferably a bromide salt thereof.

11. The aqueous solution of claim 8, comprising at least one unsubstituted or substituted quinone having a concentration of more than 1 M, preferably more than 2 M in the aqueous solution as defined by any of claim 1 to 10.

12. The aqueous solution of claim 1, comprising at least one additive, preferably selected from the group consisting of an inorganic acid and an organic base.

13. The aqueous solution of claim 12, comprising at least one acid selected from the group consisting of hydrochloric acid, sulfuric acid, phosphoric acid and nitric acid.

14. The aqueous solution of claim 12, comprising triethanolamine.

15. A method of using the aqueous solution of claim 1 as an electrolyte in batteries, in particular redox flow batteries.

16. A battery, comprising an aqueous solution of claim 1 and, optionally, an anion exchange membrane.

17. The battery of claim 16, comprising an anion exchange membrane for conducting chloride anions.

18. The battery of claim 16, comprising a cation exchange membrane to conduct lithium cations.

19. The battery of claim 16, comprising a polybenzimidazole membrane as an anion exchange membrane.
